(19) United States
(12) Patent Application Publication
(10) Pub. No.: US 2010/0253080 A1
(43) Pub. Date: Oct. 7, 2010

(54) Apparatus for Generating Electricity

(76) Inventor: Steven J. DeAngeles, Chicago, IL (US)

Correspondence Address: Docket Clerk, 1000 JORIE BOULEVARD SUITE 144, OAK BROOK, IL, 60523, US

(21) Appl. No.: 11/627,008

(22) Filed: Jan. 25, 2007

(51) Int. Cl. F03B 13/08

(52) U.S. Cl. 290/52

(57) ABSTRACT

An apparatus for generating electricity is provided. The apparatus comprises a first reservoir having a fluid, a second reservoir located below the first reservoir and receiving fluid from the first reservoir, a turbine connected to the first reservoir by a first tube, a second tube connecting the turbine to the second reservoir, a third tube connecting the first reservoir to the second reservoir, and a power source located adjacent to the second reservoir. The power source pumps fluid from the second reservoir to the first reservoir, and the fluid travels through the first tube into the turbine, thereby generating electricity.

### FIELD

This application relates generally to the generation of electricity. More particularly, this application related to generating electricity using an economic and environmentally friendly energy source and gravity.

### BACKGROUND

Earth has received major threats of climate change due to pollution, exhaustion of fossil fuels, and the environmental, social, and political risks of fossil fuels and nuclear power. Mankind's traditional uses of renewable energies such as wind, water, and solar power are widespread in developed and developing countries, but the mass production of electricity using renewable energy sources has become more commonplace only recently. Many countries and organizations promote renewable energies through taxes and subsidies.

Hydroelectric power plants use water flowing directly through turbines to power generators. Currently, rotating turbines attached to electrical generators produce commercially available electricity.

It is known to use flowing water, the wind, solar energy and other forms of power for generating electricity. In various systems, these forms of power may be combined. Generally, saving energy and the earth's resources is encouraged. Therefore, there is a need for systems which take advantage of available energy in new, environmentally friendly ways to make electricity available to users.

### SUMMARY

The apparatus for generating electricity described herein relates to a combination of an energy source and gravity to generate electricity via a hydroelectric power plant. The apparatus allows for consistent, uniform power to be provided. The apparatus also allows economic and environmentally friendly energy sources to move a fluid up to a higher reservoir so that energy is stored for later use. The apparatus comprises a first reservoir having a fluid such as water, a second reservoir having a fluid such as water, the second reservoir located below the first reservoir, a turbine connected to the first reservoir by a first tube, a second tube connecting the turbine to the second reservoir, a third tube connecting the first reservoir to the second reservoir, and an energy source located adjacent to the second reservoir. The energy source pumps water from the second reservoir to the first reservoir, and the water travels through the first tube into the turbine, thereby generating electricity. Various forms of energy may be used to accomplish the pumping.

### BRIEF DESCRIPTION OF THE DRAWINGS

Exemplary embodiments of the invention are described herein with reference to the drawings, in which:

FIG. 1 is one embodiment of the apparatus of the present application;

FIG. 2 is the apparatus of the present application shown on a building; and

FIG. 3 is exercise equipment that can be used with the apparatus of the present application.

### DETAILED DESCRIPTION

An apparatus using a fluid, such as water, an energy source, and gravity to generate electricity is described herein. The apparatus 10 may be used in combination with another energy source, such as electrical power, as a supplemental or backup source of energy. For example, when an energy source fails, the apparatus 10 may take over to provide energy in a system. The apparatus 10 allows for consistent, uniform power to be provided in a system. The apparatus 10 may include a sensor that senses when additional electricity is needed. Furthermore, the apparatus 10 may serve as a supplemental energy source which is only turned on occasionally. Thus, there is less strain on the primary energy source and on the environment.

The apparatus 10 includes a first reservoir 20 and a second reservoir 30. Although two reservoirs are shown, it should be understood that any number of reservoirs may be used in the apparatus 10. The first reservoir includes a fluid 100, such as water. The second reservoir 30 is located at a distance below the first reservoir 20. Each reservoir acts as a battery storing potential energy, which may be used at any time to supplement or replace a primary energy source. The first reservoir 20 may include an opening 22 at the bottom. The size of the opening 22 is based upon the size of the first reservoir 20 and the amount of electricity desired. The first reservoir 20 may further include a valve (not shown) to control the operation of the apparatus 10.

The apparatus 10 further comprises a turbine 40 located between the first reservoir 20 and the second reservoir 30. The turbine 40 is turned to generate electricity. The turbine 40 may include a first opening 42 on one side. The turbine 40 may further include a second opening 44 on another side. A first tube 50 connects the opening 22 at the bottom of the first reservoir 20 to the first opening 42 in the turbine 40. The first tube 50 is tapered from the first reservoir 20 to the turbine 40. The opening 22 at the bottom of the first reservoir 20 may be wider than the opening 42 on the turbine. The opening 22 may be ten times larger, for example, than the first opening 42 in order to increase the speed of the water 100 prior to entering the turbine 40. Furthermore, the length of the first tube 50 may be varied. A longer tube would create more energy, thereby resulting in more electricity. A second tube 60 connects the second opening 44 in the turbine 40 to the second reservoir 30. In alternate embodiments, the tubes may be replaced with a pipe, conduit, or any other equivalent structure.

The power to turn the turbine 40 is provided by a stream of water 100 flowing from the first reservoir 20. This water stream may be a high powered stream created by the tapering tube 50. However, it should be understood that any other method of creating a high powered stream of water may also be used. The stream of water 100 is created by placing the first reservoir 20 above the second reservoir 30. By placing the first reservoir 20 above the second reservoir 30, gravity forces the water 100 from the first reservoir 20 to the second reservoir 30. It will be understood by those skilled in the art that while the invention is described as using water in the reservoirs, any suitable fluid would be usable in the place of water and therefore the invention should not be limited to use with water.

The size of the turbine 40 may vary depending on the sizes of the reservoirs 20 and 30, and the amount of electricity desired. The turbine 40 may be connected to an electrical generator 70 by a shaft 46. The generator 70 in turn would supply electrical power to a power grid 71 or any other electrical device in need of electrical power, and the generator 70 can be scaled to meet an individual building's need or provide power to a small community. For example, during power outages, the generator 70 may be used as a temporary back-up generator. The generator 70 is connected to a transformer 74 by cables or wires 72. The cables 72 conduct an electrical current. The transformer 74 may then be connected to the power grid 71.

The apparatus 10 further includes an energy source 81 placed adjacent to the second reservoir 30 which runs a pump 80 to pump water from the second reservoir 30 back up to the first reservoir 20. In one embodiment, the energy source 81 may comprise wind energy, such as a windmill, for example. Other types of applicable energy sources will be described herein. Piping or tubing 90 is used to pump water from the second reservoir 30 to the first reservoir 20. One end of the tubing 90 is placed adjacent to the pump 80, and the other end of the tubing 90 is placed so that it discharges into the first reservoir 20. Water 100 is pumped from the second reservoir 30 to the first reservoir 20. The water 100 is then drained from the opening 22 on the bottom of the first reservoir 20 to run through the first tube 50 to provide a stream of water 100. The stream of water 100 then turns the turbine 40, thereby generating electricity. After the water turns the turbine 40, the water 100 flows back into the second reservoir 30 through the second tube 60. The cycle can be repeated indefinitely in a closed system without loss of water.

While the energy source 81 has been described as a windmill, it may also be other forms of energy. In another embodiment, the energy source 80 may be solar energy, including solar panels which provide electricity to drive the pump 80. Again, tubing 90 is used to pump water from the second reservoir 30 to the first reservoir 20. When exposed to the sun, the solar panels generate electricity to run the electric water pump 80. During sunny times, ten times the amount of water may be brought into the upper reservoir to “charge the battery.” Water 100 is pumped from the second reservoir 30 to the first reservoir 20.

The electrical generator 70 may be attached to the electrical system of a building. Alternatively, the electrical generator 70 may be attached to a house, a subdivision, or a grid depending on the electricity necessary or desired.

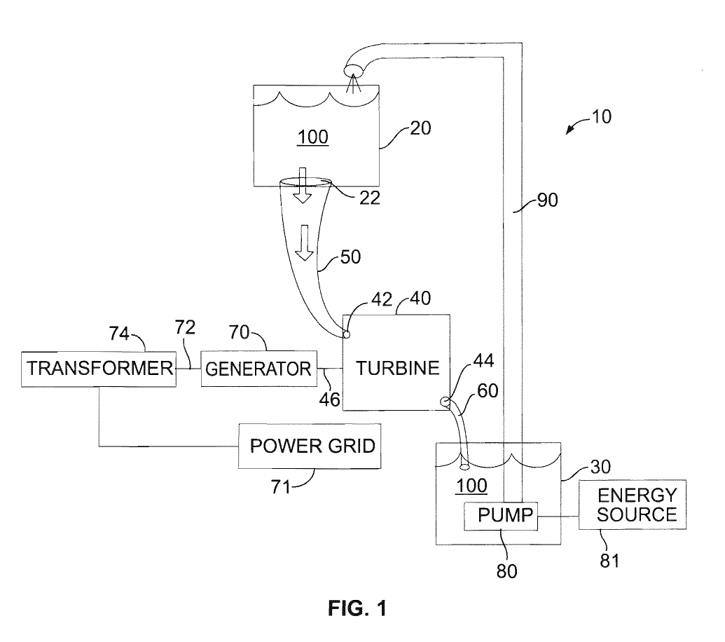

The system of FIG. 1 may be placed on a hill, a mountain, a building, or an architectural center piece with the upper reservoir being placed above the lower reservoir.

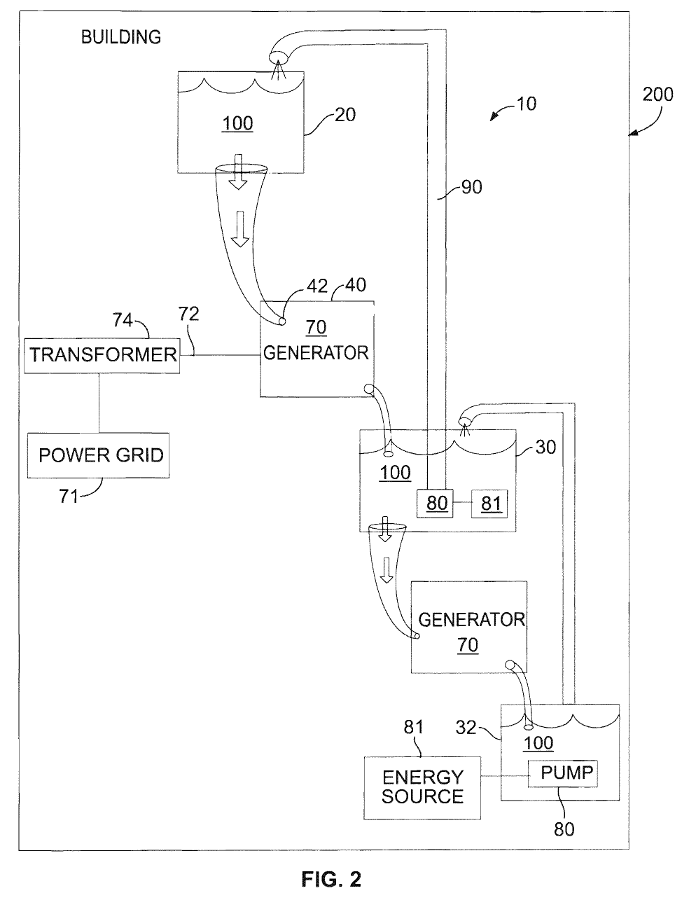

Referring to FIG. 2, the apparatus 10 may be located on a building 200 and used along with the building's electrical generators 70 to produce electricity. In this embodiment, three reservoirs 20, 30, and 32 may be used. However, more or less reservoirs may be used, depending upon the size of the building. By connecting the reservoirs in series, gravity has a greater impact on the system, and the reservoirs act as boosters to increase speed of the fluid. Each reservoir acts as a battery storing potential energy, which may be used at any time. The apparatus 10 may function in the same manner as described above. The upper reservoir 20 may be used inside the building 200, or, alternatively on the roof, where water may subsequently be collected.

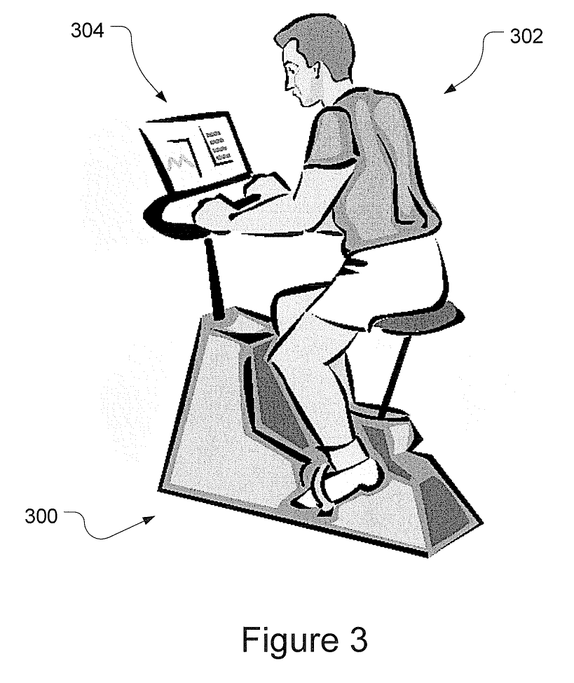

In yet another embodiment, the energy source 81 in FIGS. 1 and 2 may be manual or human energy. For example, as shown in FIG. 3, in a fitness center, a person using exercise equipment 300 such as a treadmill, elliptical machine, or exercise bicycle generates manual energy 302. The exercise equipment may include a display 304 that shows the amount of energy produced by the user. The display may include a message such as “Congratulations, you have generated ______ watts of power.” The energy that the person generates is then used along with the electric water pump 80 to pump water from the second reservoir 30 up to the first reservoir 20. In an alternate embodiment, a number of users may produce manual energy by using a number of exercise equipment. The energy produced by each user may then be combined together. The cycle then follows the same steps described above for wind or solar energy.

The first reservoir 20 functions like a battery by storing potential energy. The first reservoir 20 is large enough compared to the opening 22 in the bottom of the first reservoir 20 in order to provide a continuous flow of water 100 for a period of time, even during periods when the electric water pump is not working, or during times of little or no solar radiation. The apparatus 10 may also comprise multiple electric water pumps in order to exceed the amount of water draining by a large amount, thereby storing potential energy.

The apparatus described herein may be scaled to produce varying amounts of electricity depending on the size of the pipes or tubes, which may comprise penstock, for example, and the speed of the water 100. Because the opening 22 in the first reservoir 20 is about 10 times the size of the opening 42 in the turbine, the speed and the power of the water 100 is greatly increased. The higher speed of the water 100 turns the turbine 40 faster, thereby producing more electricity.

While certain features and embodiments of the present application have been described in detail herein, it is to be understood that the application encompasses all modifications and enhancements within the scope and spirit of the following claims.

1. A system for generating electricity comprising:
a first reservoir having a fluid;
a second reservoir located below the first reservoir;
a turbine connected to the first reservoir by a first tube;
a generator, operatively coupled to the turbine;
a second tube connecting the turbine to the second reservoir;
a third tube connecting the first reservoir to a pump;
a first pump, configured to pump water from the second reservoir to the first reservoir; and
a solar panel, coupled to and providing electric energy to the first pump;
wherein the electric energy from the solar panel, powers the first pump to pump fluid from the second reservoir to the first reservoir, and wherein, fluid travels through the first tube into and through the turbine, thereby generating electricity, the fluid being cycled repeatedly through the first and second reservoirs.

2. The system of claim 1 wherein the first pump is located adjacent to the second reservoir.

3. The system of claim 1 wherein the first tube is tapered from the first reservoir to the turbine.

4. (canceled)

5. The system of claim 3 further comprising an electric grid connected to the electrical generator, the electrical grid receiving electrical energy generated by the electrical generator.

6. (canceled)

7. The system of claim 1 further comprising a third reservoir located below the second reservoir, the third reservoir being coupled to a second pump, the second pump being coupled to an energy source, which drives the second pump, the second pump being configured to pump fluid from the third reservoir to the second reservoir using energy from said energy source.

8. A system for generating electricity in a building comprising:
a building including:
an electrical generator coupled to an electrical load;
at least a first reservoir having a fluid;
at least a second reservoir located below the first reservoir and receiving fluid from the first reservoir;
a fluid-driven turbine coupled to the electrical generator and connected to the first reservoir by a first tube;
a second tube connecting the turbine to the second reservoir;
a third tube connecting the first reservoir to the second reservoir;
a pump, configured to pump fluid from the second reservoir to the first reservoir; and
a solar panel, coupled to and providing electric energy to drive the pump;
wherein the electric energy from the solar panel powers the pump to repeatedly cycle fluid from the second reservoir to the first reservoir, and wherein the fluid travels repeatedly through the first tube and through the turbine, the turbine driving the generator, thereby generating electricity.

9. (canceled)

10. The system of claim 8 wherein the first tube is tapered from the first reservoir to the turbine.

11. The system of claim 8 wherein an electrical grid is configured to be capable of being connected to the electrical generator.

12. The system of claim 8 wherein the building is a house.

13. The system of claim 8 further comprising a subdivision connected to the electrical generator, the subdivision receiving the electrical energy generated by the generator.

14. The system of claim 8 further comprising a third reservoir located below the second reservoir, the third reservoir being operatively coupled a second pump, the second pump being operatively coupled to an energy source such that the second pump pumps fluid from the third reservoir to the second reservoir.

15. A system for generating electricity comprising:
a first reservoir having a fluid;
a second reservoir located below the first reservoir;
a turbine connected to the first reservoir by a first tube;
a generator operatively coupled to and driven by the turbine;
a second tube connecting the turbine to the second reservoir;
a first pump, operatively coupled to, and receiving fluid from the second reservoir;
a third tube connecting the pump to the first reservoir; and
a solar panel providing electric energy to the first pump;
wherein the first pump lifts fluid from the second reservoir to the first reservoir, and the fluid travels repeatedly through the first tube into and through the turbine, thereby generating electricity.

16. (canceled)

17. The system of claim 15 wherein the first tube is tapered from the first reservoir to the turbine.

18. (canceled)

19. (canceled)

20. (canceled)

21. A system for generating electricity comprising:
a first reservoir having a fluid;
a second reservoir located below the first reservoir;
a turbine connected to the first reservoir by a first tube;
a generator, operatively coupled to the turbine;
a second tube connecting the turbine to the second reservoir;
a third tube connecting the first reservoir to a pump;
a first electrically powered pump (first pump), configured to pump water from the second reservoir to the first reservoir; and
a solar panel, providing electric energy to the first pump;
wherein the solar panel provides electric power to the first pump, to lift fluid from the second reservoir to the first reservoir, and wherein, fluid travels repeatedly through the first tube into and through the turbine, thereby generating electricity.

22. The system of claim 21 wherein the first pump is located adjacent to the second reservoir.

23. The system of claim 21 wherein the first tube is tapered from the first reservoir to the turbine.

24. The system of claim 21, wherein the generator is configured to be connected to an electric grid.

25. The system of claim 21, wherein the first reservoir is on a building having vertical walls.

26. The system of claim 21, wherein the first reservoir is on a landmass that projects above its surroundings.

27. The system of claim 1, further comprising a building, having substantially vertical walls and wherein the system of claim 1 is located on said building.
